(19) United States
(12) Patent Application Publication
(10) Pub. No.: US 2014/0116089 A1
(43) Pub. Date: May 1, 2014

(54) Apparatus for Manufacturing Optical Element and Method of Manufacturing Optical Element

(71) Applicants: Seiji Yuasa, Tama-shi (JP); Shuhei Ashida, Hachioji-shi (JP); Hiroshi Nagoya, Fuchu-shi (JP)

(72) Inventors: Seiji Yuasa, Tama-shi (JP); Shuhei Ashida, Hachioji-shi (JP); Hiroshi Nagoya, Fuchu-shi (JP)

(21) Appl. No.: 14/126,160

(22) PCT Filed: Jun. 6, 2012
(86) PCT No.: PCT/JP2012/064557

§ 371 Date: Dec. 13, 2013

(30) Foreign Application Priority Data
Jun. 15, 2011 (JP) 2011-132902

(51) Int. Cl. C03B 7/14

(52) U.S. Cl. CPC C03B 7/14
USPC 65/29.1; 65/304; 65/164; 65/183; 65/29.12

(57) ABSTRACT

Provided is an apparatus for manufacturing an optical element, and a method of manufacturing an optical element, whereby variance of dropping positions of glass droplets can be suppressed even with a low-cost and simple configuration. The positions where the glass droplets are discharged from a discharged port 51c are controlled by having a predetermined force applied to the glass droplets from the wall surface of a passage 51b of a correcting member 51 in a non-contact manner, the glass droplets passing through the passage 51b. Therefore, variance of dropping positions of the glass droplets can be suppressed without surrounding the whole manufacturing apparatus. Consequently, a highly accurate optical element can be manufactured with the low-cost and simple configuration.

### TECHNICAL FIELD

The present invention relates to an apparatus for manufacturing an optical element and a method of manufacturing an optical element, particularly, a manufacturing apparatus and a manufacturing method which are suitable to form an optical element by using glass droplets.

### BACKGROUND ART

A re-heating method of manufacturing an optical element by melting optical glass, dropping a proper amount of molten glass droplet or glass flow from a nozzle tip, receiving the dropped glass by a receiving member to produce a glass gob as a mold precursor, and molding the glass gob, or a direct press method of manufacturing the optical element by directly receiving and molding the dropped glass by a metal die is used to manufacture a glass-made optical element having high precision.

Here, in a step of dropping molten glass, a flow of air due to the existence of an air conditioner or heat source, or disturbances of periphery air due to fluctuation of air caused by operations of a person or machine causes disorder of a dropping position of the glass droplet, and this is problematic as one cause of variance in quality of the glass gobs and a final molded article.

Particularly, the case of a highly accurate glass molded body or its glass gob as a precursor needs a fine droplet whose weight is controlled in an order of mg. Nevertheless, even if the weight of the glass droplet is accurately controlled, if variance of dropping positions occurs during the dropping, the dropping position of the glass droplet to be received by the receiving member such as a metal die varies, resulting in non-uniform cooling condition of glass. Thereby, variance of inner stresses of the glass gobs or molded article or variance of shapes is generated, causing variance in optical performance (particularly, aberration variance) to be generated, which results in a cause of reducing yield.

PTL1 discloses a technique which comprises a whole enclosure for surrounding the whole manufacturing apparatus of an optical element and control means for controlling the temperature of inner atmosphere surrounded by the whole enclosure so as to remain within ±5° C. of a predetermined temperature, thereby keeping the whole molding atmosphere so as not to be easily affected by the influence of temperature variation due to a change of an air flow, which results in that an optical glass element as a quality article can be manufactured in reproducibility.

### CITATION LIST

### Patent Literature

PTL1: Japanese Patent Application Publication No. 2007-186357

### SUMMARY OF INVENTION

### Technical Problem

Whereas, according to researches by the inventors of the present application, in the technique of the aforementioned PTL1, it has been proved that even if the whole molding atmosphere is surrounded, some variance of dropping positions of glass droplets remains. Thus, the remaining of even some variance of dropping positions makes difficult precise molding of an optical element. Moreover, in the technique of the PTL1, since the whole manufacturing apparatus is required to be surrounded, there is the problem in which the size of the apparatus becomes large and the cost increases.

The present invention aims to solve the aforementioned problem, and it is an object to provide an apparatus for manufacturing an optical element and a method of manufacturing an optical element, whereby variance of dropping positions of glass droplets can be suppressed, even with a low-cost and simple configuration.

### Solution to Problem

The apparatus for manufacturing an optical element recited in the claim 1 is characterized by comprising a correcting member which includes an inlet port for receiving a molten glass droplet dropped from a nozzle, a passage through which the glass droplet entered from the inlet port is passed, and an outlet port from which the glass droplet is discharged, wherein the glass droplet passing through the passage is given a predetermined force from a wall surface of the passage in a non-contact manner, thereby controlling a position where the glass droplet is discharged from the outlet port.

According to the present invention, since the glass droplet passing through the passage is given the predetermined force from the wall surface of the passage in the non-contact manner, thereby controlling the position where the glass droplet is discharged from the outlet port, it is possible suppress variance of dropping positions of the glass droplet without surrounding the whole manufacturing apparatus, and consequently, a highly accurate optical element can be manufactured even with the low-cost and simple configuration. Arranging the correcting member according to the present invention makes it possible to improve accuracy ranging from molding transfer printing surface accuracy to external shape size accuracy of an optical element when producing a glass-made optical element for which high shape accuracy is required and to increase optical element production efficiency. Moreover, using the present invention makes it possible to arbitrarily control a position of the molten dropped glass while maintaining a high glass temperature and while preventing impurities from being mixed.

The apparatus for manufacturing an optical element as recited in the claim 2 is characterized in that the predetermined force is an air pressure acting to an area between the glass droplet and the wall surface of the passage while the glass droplet passes through the passage, in the invention recited in the claim 1.

If spacing between the dropping glass droplet and the wall surface of the passage becomes small, since a flow rate between the glass droplet and the wall surface is increased, a force to be received from the wall surface increases, and on the other hand, if the spacing between the dropping glass droplet and the wall surface of the passage becomes large, since the flow rate between the glass droplet and the wall surface decreases, the force to be received from the wall surface is reduced. Utilizing this makes it possible to control a position where the glass droplet is discharged from the outlet port.

The apparatus for manufacturing an optical element as recited in the claim 3 is characterized in that the predetermined force is an electrostatic force acting to an area between the glass droplet and the wall surface of the passage while the glass droplet passes through the passage, in the invention recited in the claim 1 or 2.

In the case where an electric charge having the same positive or negative sign is charged on the glass droplet and the wall surface of the passage, if spacing between the dropping glass droplet and the wall surface of the passage becomes small, since a repulsive force between the glass droplet and the wall surface increases, a force to be received from the wall surface is increased, and on the other hand, if the spacing between the dropping glass droplet and the wall surface of the passage becomes large, since the repulsive force between the glass droplet and the wall surface decreases, the force to be received from the wall surface is reduced. Utilizing this makes it possible to precisely control a position where the glass droplet is discharged from the outlet port.

The apparatus for manufacturing an optical element as recited in the claim 4 is characterized in that a relation between a cross-sectional area A of the passage and a maximum cross-sectional area B of the glass droplet satisfies the following formula, in the invention recited in any one of the claims 1 to 3.

1.1<A/B<100 (1)

If a value of the conditional formula (1) exceeds a lower limit value, a dropping speed of the glass droplet passing through the passage is not excessively suppressed by air resistance, thereby allowing quick supply to be realized. On the other hand, if the value of the conditional formula (1) is below an upper limit value, a predetermined force given from the wall surface of the passage to the glass droplet becomes sufficient, thereby allowing the position, where the glass droplet is discharged from the outlet port, to be controlled in high accuracy. In addition, it is preferable to satisfy the following formula.

1.3<A/B<10 (1′)

The apparatus for manufacturing an optical element as recited in the claim 5 is characterized in further comprising a detection device for detecting a position of the glass droplet dropped from the nozzle, wherein the correcting member is moved in a direction intersecting a dropping direction of the glass droplet in accordance with the position of the glass droplet dropped from the nozzle, which is detected by the detection device, in the invention recited in any one of the claims 1 to 4.

It has been seen that when the glass droplet is being dropped from the nozzle during a constant time, a center of variance of dropping positions is gradually offset. Therefore, there is comprised the detection device for detecting the position of the glass droplet dropped from the nozzle, wherein the correcting member is moved in the direction intersecting the dropping direction of the glass droplet in accordance with the position of the glass droplet dropped from the nozzle which is detected by the detection device, whereby it is possible to control the position where the glass droplet is discharged from the outlet port so that the position is maintained at constant over a long period.

The apparatus for manufacturing an optical element as recited in the claim 6 is characterized in that the correcting member is formed from any one of resin, glass, metal, and ceramic, in the invention recited in any one of the claims 1 to 5.

If transparent resin or glass is used as the correcting member, the correcting member can be easily set because a dropping state can be visually confirmed. As the transparent resin, it is preferable to use acrylic resin or polycarbonate which is at a lowest price cheep and easy to handle. Since such resin is instantly melted if it comes into contact with a molten glass droplet, the resin does not easily cling, and moreover, the resin is easily sensed because it is quite obvious that the glass droplet comes into contact with the member. On the other hand, as the glass material, quartz or Pylex (a registered trademark) is desirable because this is easily gotten and its precision in inner diameter comparatively high. Moreover, the use of the metal or ceramics makes it possible to realize easy handling and to cause the correcting member to have heat-resistance. After confirming a dropping situation or dropping position while setting the resin or glass, this member may be replaced with a metal-made or ceramics-made member. Alternatively, it is also possible that a fine observation window is provided in the metal-made or ceramics-made member to make setting while confirming the position of the droplet.

The apparatus for manufacturing an optical element as recited in the claim 7 is characterized in that an inner circumference surface of the correcting member has a cylindrical shape, in the invention recited in any one of the claims 1 to 6. Since a molten glass droplet gets close to a sphere shape during the dropping, it is preferable that the inner circumstance surface of the correcting member is cylindrical-shaped. When the correcting member has a cylindrical shape, the shape of the member becomes axial symmetry with respect to a center axis, and particularly, the variance of dropping positions is stabilized. The cylindrical shape also includes an elliptic shape. Moreover, the passage may have a tapered-shape going downhill.

The apparatus for manufacturing an optical element as recited in the claim 8 is characterized in that a spiral-shaped groove is formed on the inner circumference surface of the correcting member, in the invention recited in the claim 7. Thereby, it is possible to further precisely control the position where the glass droplet is discharged from the outlet port.

The apparatus for manufacturing an optical element as recited in the claim 9 is characterized in that the inner circumference surface of the correcting member has a polygonal shape, in the invention recited in any one of the claims 1 to 8. Even the polygonal-shaped inner circumference surface of the correcting member brings some extent effect.

The method of manufacturing an optical element as recited in the claim 10 is characterized by comprising the steps of:

discharging a molten glass droplet dropped from a nozzle via a correcting member to a predetermined position;

detecting a position of the molten glass droplet dropped from the nozzle; and

moving the correcting member in a direction intersecting a dropping direction of the glass droplet, in accordance with the detected position of the glass droplet dropped from the nozzle.

It has been seen that when the glass droplet is being dropped from the nozzle during a constant time, a dropping position is gradually offset. Therefore, the position of the molten glass droplet dropped from the nozzle is detected, and the correcting member is moved in the direction intersecting the dropping direction of the glass droplet, in accordance with the detected position of the glass droplet dropped from the nozzle, whereby it is possible to control the position where the glass droplet is discharged from the outlet port so that the position is maintained at constant over a long period.

The method of manufacturing an optical element as recited in claim 11 is characterized in that the movement of the correcting member is executed after a lapse of a predetermined time since the glass droplet is initially dropped from the nozzle, or after executing a predetermined number of droppings, in the invention recited in the claim 10.

The method of manufacturing an optical element as recited in the claim 12 is characterized in that a droplet receiving member or a metal die is moved in accordance with a movement amount of the correcting member, in the invention recited in the claim 10 or 11. The adjustment by moving the droplet receiving member or the metal die by an amount according to the movement amount of the correcting member makes it possible to drop in high accuracy the glass droplet at a position which is targeted by the droplet receiving member or the metal die, at all times.

### Advantageous Effects of Invention

According to the present invention, it is possible to provide an apparatus for manufacturing an optical element and a method of manufacturing an optical element, whereby variance of dropping positions of glass droplets can be suppressed even with a low-cost and simple configuration.

### BRIEF DESCRIPTION OF DRAWINGS

FIG. 1 is a schematic diagram of an apparatus for manufacturing an optical element according to the present embodiment, where (a) illustrates a molten glass supply part GS, (b) illustrates a holding member 52 of the molten glass supply part GS and a lower die 30 of a press molding part PM, (c) and (d) illustrate the press molding part PM, (e) illustrates a modification example, and (f) illustrates another modification example.

FIG. 2 illustrates a principal part of an apparatus for manufacturing an optical element according to the present embodiment, and a chart of explaining each of functions: (a) dropping; (b) occurrence of a droplet offset; (c) correction of the droplet offset; and (d) dropping at an optional position.

FIG. 3 is a schematic diagram for an apparatus for manufacturing an optical element according to another configuration of the present embodiment.

FIG. 4 is a chart illustrating a change of variance of dropping positions depending on the existence of a correcting member.

FIG. 5 is a chart illustrating a change of variance of dropping positions when moving a correcting member in a horizontal direction.

### DESCRIPTION OF EMBODIMENTS

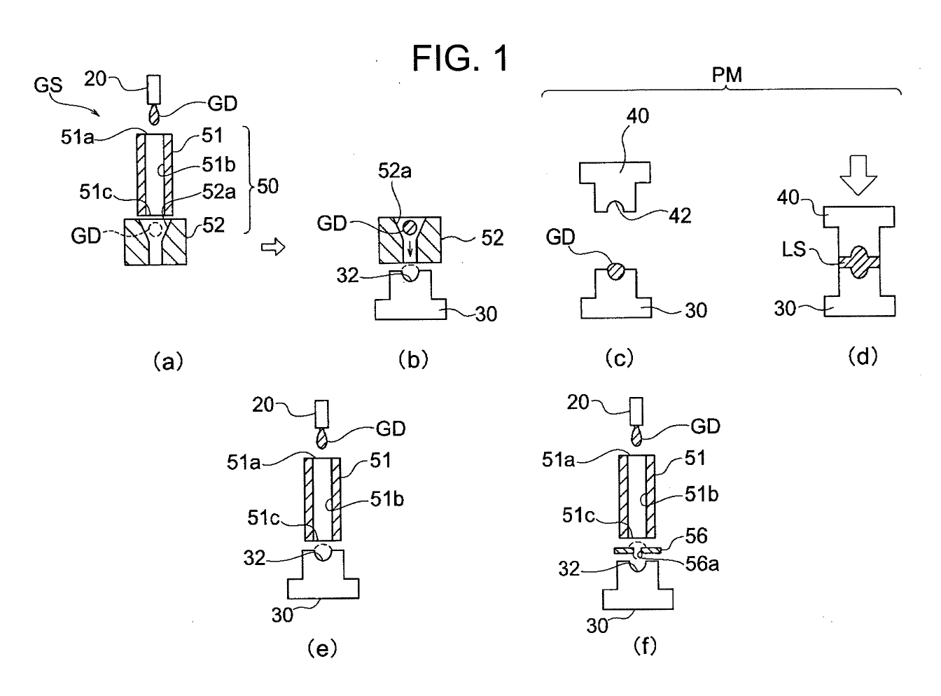

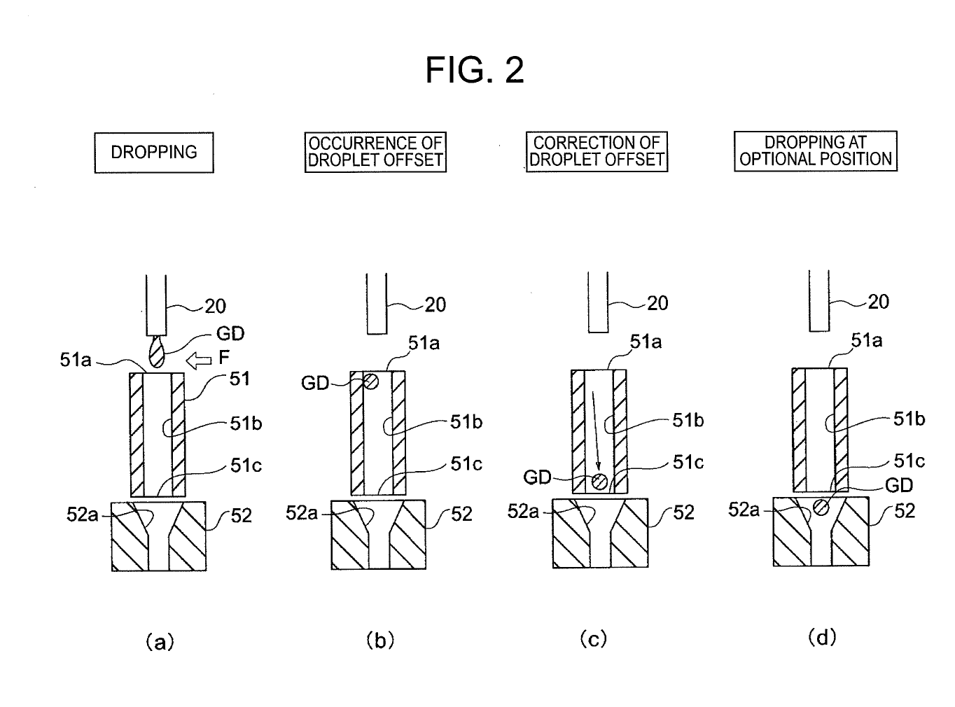

The embodiment of the present invention is described with reference to drawings, hereinafter. FIG. 1 is a schematic diagram of an apparatus for manufacturing an optical element according to the present embodiment, and FIG. 2 illustrates a principal part of the apparatus for manufacturing an optical element according to the present embodiment. The apparatus for manufacturing an optical element according to the present embodiment is preferable to form a lens as the optical element

As illustrated in FIG. 1, the apparatus for manufacturing an optical element according to the present embodiment comprises a molten glass supply part GS for supplying a molten glass droplet GD to a lower die 30 and a press molding part PM for press molding the molten glass droplet GD with a pair of upper and lower metal dies 30 and 40.

The molten glass supply part GS has a nozzle 20 which is provided at a bottom part of a melting tank (not shown) for holding heated and molten glass, and drops the molten glass droplet GD from a lower end, and a holder part 50 for temporarily holding the molten glass droplet GD naturally dropped from the lower end of the nozzle 20.

To heat the tank of the molten glass and the nozzle 20, a heater, a high frequency coil, an infrared lamp or the like can be used. Particularly, in the case of heating the members at a temperature of 1000° C. or more, a high frequency heating process is effective.

The holder part 50 has a hollow cylindrical correcting member 51 and a holding member 52 disposed under the correcting member. The correcting member 51 has an inlet port 51a for receiving the molten glass droplet GD dropped from the nozzle 20, a passage 51b as a cylinder surface through which the glass droplet entered from the inlet port 51a passes, and an outlet port 51c from which the glass droplet GD is discharged. An inner circumference surface of the passage 51b is a single cylindrical surface, but a spiral-shaped groove may be formed in this surface.

The holding member 52 has a funnel-shaped reception part 52a whose diameter is expanded upward, and has a function of holding the glass droplet GD in a non-contact manner by blowing a high temperature air flow supplied the outside from an under direction. In addition, such a holding member is described in, for example, Japanese Patent Application Publication No. 2004-231494.

An operation of the apparatus for manufacturing an optical element according to the present embodiment is described. As illustrated in FIG. 1(a), when supplying the molten glass droplet GD to the lower end of the nozzle 20, the supplied molten glass droplet GD begins to grow while remaining at the lower end of the nozzle 20, but at the time when growing up to a predetermined weight, the molten glass droplet GD naturally drops due to its own weight. The naturally dropped glass droplet GD changes to a sphere-shape or teardrop-shape due to its own surface tension and passes through the correcting member 51, whereby the discharging position of the glass droplet GD is controlled so as to be discharged within the reception part 52a of the holding member 52. At this time, the shape of the glass droplet GD is adjusted and properly cooled while the glass droplet GD is held within the reception part 52a in a non-contact manner. Thereafter, as illustrated in FIG. 1(b), if the holding member 52 of holding the glass droplet GD is moved upward of the lower die 30, and air to the reception part 52a is stopped, the glass droplet GD passes through the reception part 52a to be discharged from a lower end, and the discharged glass droplet GD is received as a glass gob on a lower die mold surface 32 having a concave shape of the lower die 30 which lies at its dropping position.

The temperature of the lower die 30 may be a room temperature, and temperature control is not particularly needed. However, when the temperature of the lower die 30 is too low, wrinkles are apt to be generated on the glass gob; therefore the temperature control by a temperature controller is effective. On the other hand, also in the upper die 40, the temperature control is not particularly needed, but the temperature control by the temperature controller is effective.

For the lower die 30 and the upper die 40, a heat-resistant material such as ceramic, cemented carbide, carbon or metal can be used, but considering an excellent thermal conductivity and a low reactive property with glass, the use of the carbon or ceramic is preferable.

As illustrated in FIG. 1(c), the lower die 30 having received the glass droplet GD at the dropping position is slides and moves in a horizontal direction to the molding position where the upper die 40 waits, illustrated in FIG. 1(c). A space in which the lower die 30 horizontally moves between the dropping position and the molding position is surrounded by an enclosure (not shown) for metal die movement space, which has heat-conductivity such as stainless steel, whereby the space is not easily affected by influences of an air flow change and temperature variation due to the air flow change. However, it is possible to obtain the same effect without providing such an enclosure. Moreover, the holding member 52 may be moved between the upper die 40 and the lower die 30, whereby the sliding movement of the lower die 30 is unnecessary.

As illustrated in FIG. 1(d), when the lower die 30 is disposed opposite to the molding position downward of the upper die 40, the upper die 40 is driven in an up-and-down direction by the press molding means. The glass droplet GD put on the lower die molding surface 32 of the lower die 30 is molded in pressure between the lower die molding surface 32 of the lower die 30 and the upper die molding surface 42 of the upper die 40. Thereafter, opening the mold makes it possible to take out the molded lens LS. In addition, it is also possible to directly discharge the glass droplet GD on the lower die 30 without using the holding member 52.

FIG. 1(e) illustrates a manufacturing step for an optical element according to a modification example, and here the glass droplet GD is directly supplied from the correcting member 51 to the lower die 30. The lower die 30 having received the glass droplet GD at the dropping position slides and moves in a horizontal direction to the molding position where the upper die 40 waits, as illustrated in FIG. 1(c).

FIG. 1(f) illustrates a manufacturing step for an optical element according to another modification example, and here a plate member 56 having an opening 56a is arranged between the correcting member 51 and the lower die 30. The glass droplet GD having naturally dropped from the nozzle 20 drops on an upper surface of the plate member 56, but the droplet is squeezed when passing through the opening 56a, resulting in the drop of only a suitable amount to the lower die 30. The plate member 56 is described in Japanese Patent Application Publication No. 2002-154834.

Next, referring to FIG. 2, a function of the correcting member 51 is described. In addition, here it is assumed that an axial line of the correcting member 51 coincides with an axial line of the reception part 52a of the holding member 52. First, as illustrated in FIG. 2(a), at the moment that the molten glass droplet GD having grown up to a predetermined weight at the lower end of the nozzle 20 naturally drops with its own weight, the droplet is given a slight external force F due to a convection current or fluctuations of air, thus the droplet is assumed to have begun to drop away from the axial line of the nozzle 20.

As illustrated in FIG. 2(b), the dropped glass droplet GD immediately enters from an inlet port 51a of the correcting member 51 to a passage 51b. The glass droplet GD passing through the passage 51b is given a force from a wall surface of the passage 51b in a non-contact manner. One of forces is an air pressure which acts to an area between the glass droplet GD and the wall surface of the passage 51b while the glass droplet GD passes through the passage 51b.

For example, in the case where an inner circumstance shape of the correcting member 51 is cylindrical shape, the passing of the glass droplet GD through the cylindrical-shaped passage 51b generates a difference in pressure due to a difference in flow of air on a side surface of the glass droplet GD. The generation of this difference in pressure generates a force for centering the glass droplet GD at the center, thereby allowing the variance of discharging positions of the glass droplet GD, that is, dropping positions thereof to be suppressed. Therefore, it is preferable that a cross section of the passage 51b has an axial symmetry shape, and particularly, if the cross section has a cylindrical shape resulting in a uniform distance between the surface of the glass droplet GD and the wall surface, the variance of the dropping positions is stabilized.

Moreover, another force given to the glass droplet GD is a repulsive force due to static electricity to be generated in the case where a charge having the same positive or negative sign is charged between the surface of the glass droplet GD and the wall surface of the passage 51b.

In the case where the correcting member 51 is made of a non-conductor such as, for example, an acrylic-polycarbonate-vinyl chloride tube, a glass tube, or a quartz tube, the correcting member is easily charged with static electricity. In case where the glass droplet GD and the wall surface of the passage 51b are charged with the charge having the same positive or negative sign, when molten glass passes through the passage, the molten glass receive a repulsive force due to the static electricity to be centered at the center. Thus, the variance of the discharging positions of the glass droplet GD, that is, the dropping positions thereof can be suppressed. Similarly, in the case where the correcting member 51 is formed from a metal material such as, for example, stainless steel, iron, aluminum, or copper, the same effect can be obtained by causing the correcting member to be charged with either positive or negative static electricity.

However, if the passage 51b has a cylindrical shape, there is predicted the case where initial positioning becomes difficult. By contrast, if the cross section of the passage 51b is set so as to have an elliptic shape, while the centering effect in a short axis direction in the cross section becomes strong, there is room in size in a long axis direction; therefore the initial positioning becomes easy. Moreover, if a spiral-shaped groove is provided in the passage 51b, the dropping positions do not vary because of being axial symmetry, and moreover the spiral-shaped groove can be used as a bypath of air; therefore this technique is effective in the case where a devise with an air flow rising from an under direction is provided, or the case of being used for a device with many disturbances due to an air flow, as in the holding member 52 or the like.

Furthermore, in the case where the inner circumstance cross section of the correcting member 51 is set so as to have a polygonal shape, it is possible to carry out accurate positioning for the correcting member by providing a measurement window in the member and measuring its inner position using laser light or the like, because a planar surface exists in an inner circumstance. Moreover, if the inner circumference surface is set so as to result in a mirror face, the laser light is easily reflected, which makes it possible to measure the position of the glass droplet GD in more high precision. Moreover, setting the inner circumference cross section so as to have a polygonal shape causes its corners to release disturbances of an air flow and causes a surface center part to have a rectification effect for the glass droplet; therefore this technique is effective in the case where a devise with an air flow rising from an under direction is provided, or the case of being used for a device with many disturbances due to an air flow, as in the holding member 52 or the like.

In the foregoing manner, the glass droplet GD is centered so as to get near to the axis line of the correcting member 51 during the passing through the passage 51b (see FIG. 2(c)). Accordingly, as illustrated in FIG. 2(d), at the time when the glass droplet GD is discharged from the outlet port 51c of the correcting member 51, the glass droplet is discharged nearly converging at a position near the axis line of the correcting member 51, which results in being received at an appropriate position by the reception part 52a of the holding member 52.

If the glass droplet GD is offset from the axis line of the reception part 52a, there is a possibility that the droplet is deformed hitting on the circumference surface of the reception part 52a or dust is mixed therein. Moreover, even if the dropping position does not vary largely enough to touch on the reception part 52a, it is preferable to concentrate the dropping positions on a center periphery of the reception part 52a as many as possible. This is because the coming-off from the center of the reception part 52a causes a flow of air hitting on the glass droplet GD to the deviated, which results in different cooling states of the surface of the glass droplet GD depending on its direction. If the cooling state of the surface of the glass droplet GD deviates, the variance of inner stress disturbances of the glass droplet GD is generated. As the variance of the stress distributions becomes large, there are generated cracks inside the glass droplet GD or wrinkles on its surface, thus there is a possibility that the glass gob becomes defective. Moreover, even in the case where the glass gob does not become defective, if the glass gob having the variance of the stress distributions is used for molding to produce an optical element, and there is a possibility that the variance of birefringence distributions not to be ignored is individually generated in that optical element. This variance of birefringence distributions generates lens performance variance of a final optical element, and there is a possibility that a molding yield of the optical element deteriorates. By contract, the use of the correcting member 51 according to the present embodiment can avoid such a problem.

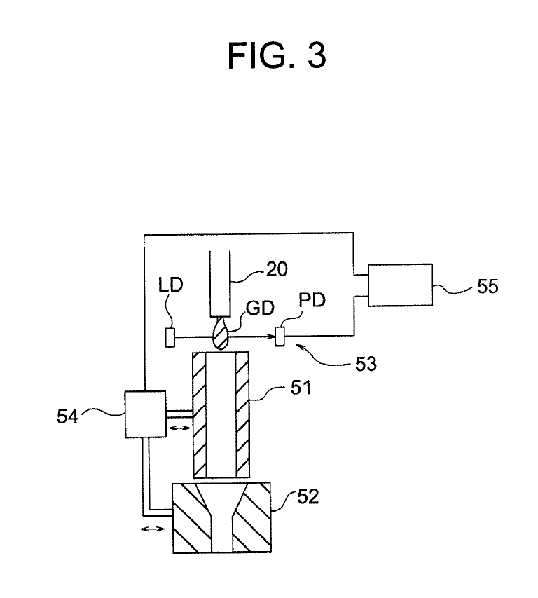

FIG. 3 is an outline cross-sectional diagram of a molten glass supply part GS according to another embodiment. In the present embodiment, there are provided a detection device 53 for detecting a position of the glass droplet GD dropped from the nozzle 20, a actuator 54 for driving the correcting member 51, and a control device 55 for controlling the drive of the actuator 54 in response to a signal from the detection device 53.

More specifically, the detection device has an outgoing part LD for projecting an inspection light beam horizontally toward the glass droplet GD dropped from the nozzle 20, and a light reception part PD to which the inspection light beam passing through the glass droplet GD is entered. Moreover, the actuator 54 synchronizes the correcting member 51 and the holding member 52 with each other so as to be driven in a horizontal direction.

According to the present embodiment, a position of the glass droplet GD immediately before it is dropped from the nozzle 20 is detected by receiving the inspection light beam by the light reception part PD, and the control device 55 having received a signal from the light reception part PD drives the correcting member 51 and the holding member 52 by the actuator 54 in accordance with the position of the glass droplet GD immediately before it is dropped, for example, in a direction opposite to an offset direction of the glass droplet GD to the axis line, thereby allowing the discharging position of the glass droplet GD to be controlled in more high precision. In addition, such positional control of the correcting member 51 and holding member 52 may be performed every time, or it is also possible to perform the control in predetermined timing in accordance with, for example, a time period from a manufacture beginning or the number of shots. Moreover, in the case of a direct press as illustrated in FIG. 1(e), the actuator 54 is driven in a horizontal direction synchronizing the correcting member 51 and the lower die 30 with each other.

The adjustment of moving the holding member 52 or the metal die 30 as the droplet receiving member by an amount according to a movement amount of the correcting member 51 makes it possible to drop the glass droplet GD in high precision at a position which is targeted by the holding member 52 or the metal die 30, all the time. For example, if a detected dropping offset amount is smaller than ⅓ times as large as a measured variance amount of dropping positions, it is not necessary to dare to adjust the holding member 52 or the metal die 30. When the dropping position offset amount is equal to or larger than ⅓ times as large as the measured variance, it is necessary to move and adjust the holding member 52 or the metal die 30 for adjustment by an amount according to the movement amount of the correcting member 51. Such fine adjustment makes it possible to drop in high precision the glass droplet GD having a high temperature at a targeted position all the time.

Since a manufacturing apparatus with the present invention being applied is an apparatus for processing molten glass, a glass melting furnace, a cooling chiller, an air conditioner or the like is arranged and operated in a periphery of the manufacturing apparatus. Disturbances of peripheral air easily occur due to thermal or external factors, and the variance of the glass dropping positions is generated. Moreover, vibration or electric noise from peripheral apparatuses is propagated to the manufacturing apparatus, and their complex influence affects the dropping nozzle or the glass droplet passage, and the precision of the glass dropping position is apt to be in disorder. Accordingly, in addition to sudden disorder of the dropping position, there is also supposed the case where the disorder changes with time in a long period of several hours to several days or several weeks. According to the present invention, moving the correcting member in accordance with the change with time of the dropping position in addition to the sudden change thereof allows the glass dropping position to be held at the targeted position, all the time.

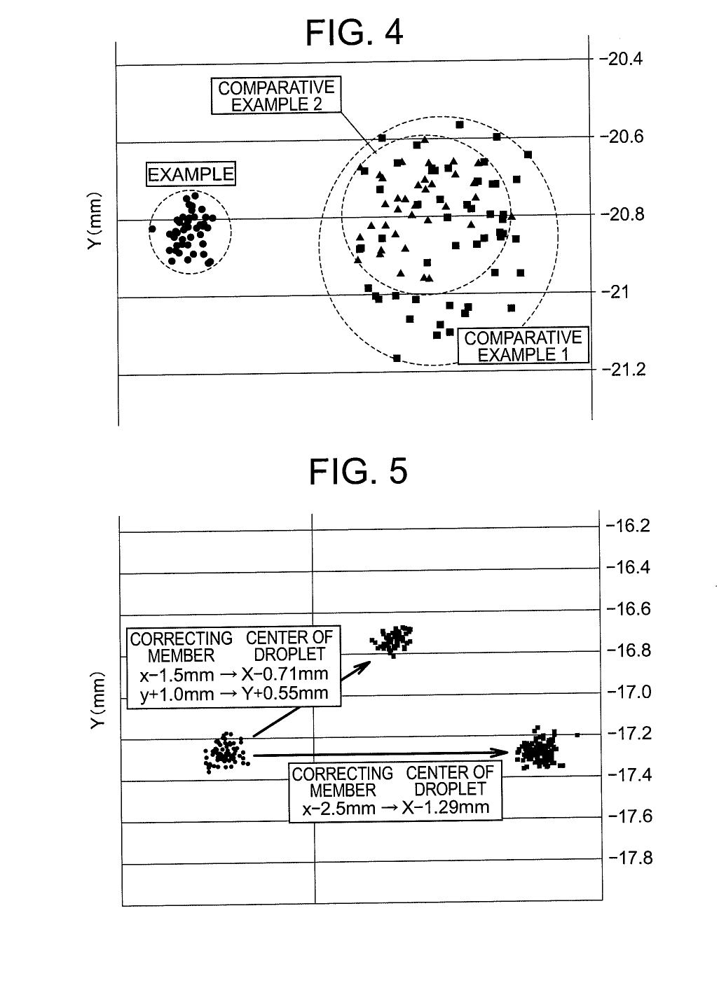

A result which the inventors have been studied is described. FIG. 4 is a diagram illustrating a change of variance of dropping positions depending on the existence of the correcting member. Here, it is assumed that a diameter of the glass droplet is about 7 mm and a passage diameter of the correcting member is 9 mm. Therefore, a cross-sectional area ratio A/B in both of them is about 1.7. A comparative Example 1 in FIG. 4 is an example in which the variance has been determined by dropping a plurality of glass droplets from the nozzle without providing the present invention's correcting member, and a comparative Example 2 is an example in which a windbreak (a square cylindrical shape with one side being 100 mm) as described in, for example, Japanese Patent Application Publication No. 2007-186357 is provided on a lower circumference of the nozzle, instead of providing the present's correcting member, and the example is an example in which the present's correcting member is provided under the nozzle.

As illustrated in FIG. 4, it is possible to confirm that in the case of the present example, the variance range (area conversion) results in ⅙ as compared with the comparative Example 1, and the variance range results in not more than ¼ even as compared with the comparative Example 2. In short, according to the present invention, it has been seen that not only the removal of disturbances due to peripheral air but also the application of a variance suppression force caused within the passage of the correcting member to the glass droplet allows the variance of dropping positions to be positively reduced. In addition, according to the study result made by the inventors, it has been proved that a cross-sectional area ratio A/B=1.1 to 100 (a glass droplet diameter: 2 mm to 21 mm) brings a sufficient effect.

FIG. 5 is a diagram illustrating a change of variance of dropping positions in the case where the correcting member is moved in a horizontal XY direction. Conventionally, it has been difficult to drop a molten glass droplet having a temperature of nearly 1000° C. at an arbitrary position. By contrast, according to the present invention, it is possible to drop a heated molten glass droplet at an arbitrary position. In FIG. 5, in the case where the correcting member is moved by −2.5 mm only in an X direction and in the case where the correcting member is moved by −1.5 mm in the X direction and by +1.0 mm in a Y direction, the increase of the variance has not been confirmed as compared with the case where the correcting member is not moved. In short, the movement of the correcting member makes it possible to arbitrarily move the dropping position while maintaining the range of the variance.

According to the inventors' study result, it has been seen that a relation between a movement amount of the correcting member and a discharge position of the glass droplet is expressed by the following formula.

ΔY=A·ΔX (2)

### Where

ΔY: an offset amount of a discharge position of the glass droplet,
ΔX: a movement amount of the correcting member, and A: coefficients (0.2 to 0.8).

The present invention is not limited to the embodiment described in the specification, and including another embodiment or modification is clear for one skilled in the art from the embodiment or technical idea described in the present specification. The descriptions and embodiment in the specification aim to give only an exemplification, and the technical scope of the present invention is defined by the under-mentioned claims. For example, the optical element is not limited to a lens.

### REFERENCE SIGNS LIST

20 Nozzle
30 Lower die
32 Lower die molding surface
40 Upper die
42 Upper die molding surface
50 Holder part
51 Correcting member
52 Passage
51a Inlet port
51b Passage
51c Outlet port
52 Holding member
52a Reception part
53 Detection device
54 Actuator
55 Control device
GD Glass droplet
GS Molten glass supply part
LD Outgoing part
PD Light reception part
PM Press molding part

1. An apparatus for manufacturing an optical element, comprising a correcting member which includes an inlet port for receiving a molten glass droplet dropped from a nozzle, a passage through which the glass droplet entered from the inlet port is passed, and an outlet port from which the glass droplet is discharged,
wherein the glass droplet passing through the passage is given a predetermined force from a wall surface of the passage in a non-contact manner, thereby controlling a position where the glass droplet is discharged from the outlet port.

2. The apparatus for manufacturing an optical element as recited in claim 1, wherein the predetermined force is an air pressure acting to an area between the glass droplet and the wall surface of the passage while the glass droplet passes through the passage.

3. The apparatus for manufacturing an optical element as recited in claim 1, wherein the predetermined force is an electrostatic force acting to an area between the glass droplet and the wall surface of the passage while the glass droplet passes through the passage.

4. The apparatus for manufacturing an optical element as recited in claim 1, wherein a relation between a cross-sectional area A of the passage and a maximum cross-sectional area B of the glass droplet satisfies the following formula,
1.1<A/B<100 (1)

5. The apparatus for manufacturing an optical element as recited in claim 1, further comprising a detection device for detecting a position of the glass droplet dropped from the nozzle, wherein the correcting member is moved in a direction intersecting a dropping direction of the glass droplet in accordance with the position of the glass droplet dropped from the nozzle, which is detected by the detection device.

6. The apparatus for manufacturing an optical element as recited in claim 1, wherein the correcting member is formed from any one of resin, glass, metal, and ceramic.

7. The apparatus for manufacturing an optical element as recited in claim 1, wherein an inner circumference surface of the correcting member has a cylindrical shape.

8. The apparatus for manufacturing an optical element as recited in claim 7, wherein a spiral-shaped groove is formed on the inner circumference surface of the correcting member.

9. The apparatus for manufacturing an optical element as recited in claim 1, wherein an inner circumference surface of the correcting member has a polygonal shape.

10. A method of manufacturing an optical element, comprising the steps of:
discharging a molten glass droplet dropped from a nozzle via a correcting member to a predetermined position;
detecting a position of the molten glass droplet dropped from the nozzle; and
moving the correcting member in a direction intersecting a dropping direction of the glass droplet, in accordance with the detected position of the glass droplet dropped from the nozzle.

11. The method of manufacturing an optical element as recited in claim 10, wherein the movement of the correcting member is executed after a lapse of a predetermined time since the glass droplet is initially dropped from the nozzle, or after executing a predetermined number of droppings.

12. The method of manufacturing an optical element as recited in claim 10, wherein a droplet receiving member or a metal die is moved in accordance with a movement amount of the correcting member.
